(19) United States
(12) Patent Application Publication
(10) Pub. No.: US 2011/0018234 A1
(43) Pub. Date: Jan. 27, 2011

(54) PROCESS FOR MANUFACTURING A TEXTILE SUPPORT, AND SAID TEXTILE SUPPORT

(76) Inventors: Bertrand Bordes, Lyon (FR); Jean-Louis Bertry, Lyon (FR)

Correspondence Address: BUCHANAN, INGERSOLL & ROONEY PC, POST OFFICE BOX 1404, ALEXANDRIA, VA, 22313-1404, US

(21) Appl. No.: 12/529,603

(22) PCT Filed: Feb. 29, 2008
(86) PCT No.: PCT/EP2008/052527

§ 371 Date: Aug. 17, 2010

(30) Foreign Application Priority Data
Mar. 2, 2007 (FR) 07 01553

(51) Int. Cl. B60R 21/235; B05D 1/28; B32B 27/00

(52) U.S. Cl. 280/728.1; 427/211; 428/102

(57) ABSTRACT

Textile supports having a silicone coating, the weight of the silicone coating being reduced without correspondingly reducing the functional properties of the support obtained, are produced by a process which includes the following steps: 1) formulating a silicone composition (5), 2) applying the silicone composition prepared in step 1) onto one or both face surfaces of a textile support (4); and 3) drying and/or crosslinking the coating deposited in step 2), preferably by heating to a temperature of up to 210° C., and wherein, the application in step 2) of the silicone composition onto the textile support is carried out by transfer coating employing a coating machine that includes a coating head having at least three elements, i.e., a press roll (1), a coating roll (2) and a metering roll (3), and optionally other metering elements, only the coating roll and press roll being in contact with the textile support.

The general field of the invention is that of manufacturing textile supports that comprise a silicone coating. In the present description, the expression “textile supports” is understood to mean fibrous, woven, plaited, knitted or non-woven supports.

The silicone coating is obtained from a silicone composition, in particular a crosslinkable silicone composition, comprising a system that promotes the anchoring of the silicone to the surface of the textile, and more particularly those of two-component or multi-component type, that can be crosslinked by hydrosilylation or polyaddition reactions of the unsaturated (alkenyl, e.g. Si-Vi) groups of one polyorganosiloxane to hydrogens of the same or of another polyorganosiloxane, in order to produce an elastomer in a thin film. Other silicone compositions are also suitable, such as those obtained by polycondensation, emulsions or compositions in a solvent phase.

These compositions are suitable, inter alia, as coatings, for example for the protection, mechanical reinforcement or functionalization of said textile supports. These silicone compositions have found a large market in the coating of flexible—woven, plaited, knitted or non-woven—materials used in the field of sports clothing or for manufacturing bags for the personal protection of the occupants of vehicles, also known as “airbags”.

For more details concerning the use of a silicone formulation for the durable functionalization of textiles for sports clothing, reference may be made in particular to French patent FR-A-2 865 223.

For further details on airbags, reference may be made in particular to French patent FR-A-2 668 106.

Conventionally, airbags are formed from a cloth of synthetic fiber, for example of polyamide, covered on at least one of its faces with a layer of a silicone-type elastomer. The presence of such a protective layer or coating is dictated by the fact that the gases released by the gas generator (for example: carbon monoxide, NOₓ) in the event of impact, are extremely hot and contain incandescent particles capable of damaging the polyamide airbag. The inner elastomeric protective layer must therefore be particularly resistant to the high temperatures and to the mechanical stresses. It is also important that this elastomeric coating is in the form of a thin uniform film that adheres perfectly to the synthetic fabric support forming the walls of the airbag.

Furthermore, in order to prevent the gases released by the gas generator from passing into the passenger compartment, it is also important to ensure a good and constant impermeability of the airbag. In addition, the use of more mechanically and thermally aggressive gas generators leads to supplementary stresses at the seams of the airbag. These add to the physical stresses linked to the deployment of the airbag and may cause tearing of the elastomer-coated fabric and opening of these seams. This results in a point of escape for the hot gas, emanating from the generator, through the seams generating points of weakness that are the origin of tearing, of edgecombing (fraying) or even of rupture of certain airbags. The elastomeric coating must therefore have optimum mechanical properties, especially good resistance to tearing and edgecombing (ability of the coated fabric to withstand edgecombing of the seams of the airbag).

The Applicant proposed, in document WO 2005/045123, crosslinkable silicone compositions that make it possible to achieve these objectives.

One of the techniques for applying a silicone composition to a support is coating. In the field of textile supports, conventional doctor blade systems are used that enable the coating of textile supports at thicknesses of 25 to 200 g/m² and at speeds of 10 to 60 m/minute.

However, in certain applications, in particular for the manufacture of airbags and sports clothing, for reasons of economic competitiveness, it is sought to apply very thin layers of silicone. The elastomeric coating must then make it possible to achieve all the aforementioned objectives, even with small amounts deposited.

However, the coating technique using a doctor blade has some limitations. Specifically, in order to reduce the thicknesses, the doctor blade is pushed against the textile support with a high pressure, so that the doctor blade damages the fibers of the support. In addition, the coating speed must be limited, as the higher the speed, the greater the weight deposited. Similarly, a high rate of travel favors the degradation of the textile support. Finally, it is difficult to obtain, with this coating technique, masses per unit area of less than 25 g/m². However, low masses per unit area are desired in order to reduce the costs and high rates of travel are desired in order to increase productivity. In addition, it is sought to improve the quality of the protection or of the functionalization without using more materials, or even by reducing the amount thereof. These limitations may be partially overcome by using systems that comprise solvents in order to dilute the coating compositions. However, this solution is not satisfactory since the use of solvents then requires the removal thereof or the recycling thereof.

Furthermore, when the airbags are manufactured from a fabric comprising two plies assembled by one-step weaving technology, the doctor blade is hampered by the transition zone that connects the zone of the fabric comprising a single ply and the zone of the fabric comprising two plies, so that the thickness of silicone coating at the transition zone is neither sufficient nor homogeneous. The usual solution consists in increasing the amount of silicone applied to the whole of the fabric so as to be sure to have a continuous coating at the transition zone, but this is not satisfactory from an economic point of view.

The present invention aims to overcome the drawbacks of the prior art.

In this perspective, one of the main objectives of the present invention is to provide a process for manufacturing a textile support comprising a silicone coating, said process making it possible to reduce the mass per unit area of the silicone coating, without however reducing the functional properties of the support obtained.

Another main objective of the present invention is to provide a process for manufacturing a textile support comprising a silicone coating, the mass per unit area of which may be easily reduced, until it reaches a low value, for example below 20 g/m², while obtaining a silicone coating in the form of a thin, continuous and uniform film having optimal functional properties, especially that ensures a good and constant impermeability and a good resistance to tearing and to edgecombing.

Another main objective of the present invention is to provide a process for manufacturing a textile support comprising a silicone coating that makes it possible to have high rates of travel.

Another main objective of the present invention is to provide a process for manufacturing a textile support comprising a silicone coating that makes it possible not to damage said support.

Another main objective of the present invention is to provide a process for manufacturing a textile support that makes it possible to use crosslinkable silicone compositions that are solvent free and have a high viscosity.

Another main objective of the present invention is to advocate the use of such a process for manufacturing a textile support used to form an airbag for protecting a vehicle occupant.

These objectives, among others, are achieved by the present invention which firstly relates to a process for manufacturing a textile support, comprising a silicone coating on one or two faces, said process comprising the following steps:
1) the preparation of a silicone composition;
2) the application of the silicone composition prepared in step 1) to one or two faces of a textile support; and
3) the drying and/or the crosslinking of the deposition formed in step 2), preferably by heating at a temperature which may reach 210° C.;
   characterized in that the application, according to step 2), of the silicone composition to the textile support is carried out by transfer coating using a coating machine comprising a coating head having at least three elements, that is to say a press roll, a coating roll and a metering roll, the optional other elements being metering elements, only the coating and press rolls being in contact with the textile support.

In the present description, the expression “transfer coating” is understood to mean the formation of a silicone film on the coating roll which is then transferred to the textile support. The film formed on the coating roll is of substantially constant thickness and is applied to the textile support retaining this constant thickness. A coating of essentially homogeneous thickness is thus obtained.

The manufacturing process according to the invention is advantageous in that it makes it possible to apply the transfer coating technique to a textile support in order to obtain a coated support that has better functional performances than the same coated support, of the same mass per unit area, but that is coated using a doctor blade.

Therefore, the manufacturing process according to the invention makes it possible to obtain a coated support having the same functional performances as existing coated supports, with a coating that has a lower average mass per unit area and coating speeds greater than that which is conventionally encountered with coating systems that use a doctor blade.

In the present document, reference is made to the following “silicone” nomenclature in order to represent the siloxy units (“Chemistry and technology silicones” Walter NOLL Academic Press 1968 Table 1 page 3”):
M: (R^{o})₃SiO_{1/2},
M^{Alc}: (R^{o})₂(Alc)SiO_{1/2},
D: (R^{o})₂SiO_{2/2},
D^{Alc}: (R^{o})(Alc)SiO_{2/2},
M′: (R^{o})₂(H)SiO_{1/2},
D′: (R^{o})(H)SiO_{2/2},
M^{CH}: (R^{o})₂(OH)SiO_{1/2},
D^{CH}: (R^{o})(OH)SiO_{2/2},
T: (R^{o})SiO_{3/2},
Q: SiO_{4/2},
where R^{o} is chosen from linear or branched alkyl groups having from 1 to 8 carbon atoms inclusive (e.g. methyl, ethyl, isopropyl, tert-butyl and n-hexyl), optionally substituted by at least one halogen atom (e.g. 3,3,3-trifluoropropyl), and also from aryl groups (e.g. phenyl, xylyl and tolyl),
Alc=alkenyl, preferably vinyl (denoted Vi), or allyl.

According to a first variant, the silicone composition is a crosslinkable composition (A) comprising:
the components (a-1) or (a-2):
   (a-1) corresponding to at least one polyorganosiloxane capable of crosslinking via the action of a catalyst based on at least one organic peroxide; and
   (a-2) corresponding to a mixture of polyorganosiloxanes capable of crosslinking via polyaddition reactions comprising:
      at least one polyorganosiloxane (I) having, per molecule, at least two C₂-C₆ alkenyl groups bonded to the silicon; and
      at least one polyorganosiloxane (II) having, per molecule, at least two hydrogen atoms bonded to the silicon;
an effective amount of crosslinking catalyst consisting: when (a-1) is used, in at least one organic peroxide and when (a-2) is used, in at least one metal or metal compound from the platinum group (III);
optionally at least one adhesion promoter (IV);
optionally at least one mineral filler (V);
optionally at least one crosslinking inhibitor (VI);
optionally at least one polyorganosiloxane resin (VII); and
optionally one or more functional additives for conferring specific properties.

The polyorganosiloxane (a-1) capable of crosslinking via the action of a catalyst based on at least one organic peroxide is advantageously a product having siloxy units of formulae:

R¹ₐSiO_{(4-a)/2} (a.1)

in which:
R¹ represents a hydrocarbon-based group having from 1 to 12 carbon atoms, preferably from 1 to 8 carbon atoms, and being optionally substituted; and
a is 1, 2 or 3.

Preferably, R¹ is chosen from:
methyl, ethyl, propyl, butyl, hexyl and dodecyl groups;
cycloalkyl groups such as for example cyclohexyl;
alkenyl groups such as for example vinyl, allyl, butenyl and hexenyl groups;
aryl groups such as for example phenyl, tolyl and aralkyl such as β-phenylpropyl, groups; and
the groups cited above in which one or more hydrogen atoms are replaced by one or more halogen atoms; a cyano group or an equivalent of a cyano group such as for example a chloromethyl, trifluoropropyl or cyanoethyl group.

More preferably still, the polyorganosiloxanes (a-1) are terminated at the end of the chain by trimethylsilyl, dimethylvinyl, dimethylhydroxysilyl or trivinylsilyl units.

In one particularly advantageous embodiment, the polyorganosiloxanes (a-1) contain at least two alkenyl groups per molecule.

Among the organic peroxides that are useful according to the invention, mention may be made of benzoyl peroxide, bis(p-chlorobenzoyl)peroxide, bis(2,4-dichlorobenzoyl)peroxide, dicumyl peroxide, di-t-butyl peroxide, 2,5-dimethyl-2,5-di(t-butylperoxy)hexane, t-butyl perbenzoate, t-butylcumyl peroxide, halogenated derivatives of the peroxides cited above such as for example bis(2,4-dichlorobenzoyl)peroxide, 1,6-bis(p-toluoylperoxycarbonyloxy)hexane, 1,6-bis(benzoylperoxy-carbonyloxy)hexane, 1,6-bis(p-toluoylperoxycarbonyl-oxy)butane and 1,6-bis(2,4-dimethylbenzoylperoxy-carbonyloxy)hexane.

According to one preferred embodiment of the process according to the invention, the crosslinkable coating silicone composition (A) used comprises polyorganosiloxanes capable of crosslinking via polyaddition reactions. Such a composition is for example described in international application WO 2005/045123.

Preferably, such a composition (A) comprises a mixture formed from:
(a) at least one polyorganosiloxane (I) having, per molecule, at least two C₂-C₆ alkenyl groups bonded to the silicon;
(b) at least one polyorganosiloxane (II) having, per molecule, at least two hydrogen atoms bonded to the silicon;
(c) a catalytically effective amount of at least one catalyst (III), composed of at least one metal belonging to the platinum group;
(d) at least one adhesion promoter (IV);
(e) optionally at least one mineral filler (V);
(f) optionally at least one crosslinking inhibitor (VI);
(g) optionally at least one polyorganosiloxane resin (VII);
(h) optionally at least one coloring additive (VIII); and
(i) optionally at least one additive (IX) for improving the fire resistance.

The polyorganosiloxane POS (I) is one of the main constituents of the composition (A) for the method of crosslinking via polyaddition reactions. Advantageously, it has units of formula:

WₐZ_{b}SiO_{(4(a+b))/2} (I.1)

in which:
W is an alkenyl, preferably vinyl group;
Z is a monovalent hydrocarbon-based group, free of any action unfavorable to the activity of the catalyst and chosen from alkyl groups having from 1 to 8 carbon atoms inclusive, optionally substituted by at least one halogen atom, and also from aryl groups;
a is 1 or 2, b is 0, 1 or 2 and a+b is between 1 and 3,
and optionally other units of average formula:

Z_{c}SiO_{(4-c)/2} (I.2)

in which Z has the same meaning as above and c has a value between 0 and 3.

The Z groups may be identical or different.

The term “alkenyl” is understood to mean a substituted or unsubstituted, linear or branched, unsaturated hydrocarbon-based chain having at least one olefinic double bond, and more preferably only one double bond. Preferably, the “alkenyl” group has from 2 to 8 carbon atoms, better still from 2 to 6. This hydrocarbon-based chain optionally comprises at least one heteroatom such as O, N, S.

Preferred examples of “alkenyl” groups are the vinyl, allyl and homoallyl groups; vinyl being particularly preferred.

The term “alkyl” denotes a saturated, cyclic, linear or branched hydrocarbon-based chain that is optionally substituted (e.g. by one or more alkyls), preferably having from 1 to 10 carbon atoms, for example from 1 to 8 carbon atoms, better still from 1 to 4 carbon atoms.

Examples of alkyl groups are especially methyl, ethyl, isopropyl, n-propyl, tert-butyl, isobutyl, n-butyl, n-pentyl, isoamyl and 1,1-dimethylpropyl.

The term “aryl” denotes an aromatic hydrocarbon-based group, having from 6 to 18 carbon atoms, that is monocyclic or polycyclic and preferably monocyclic or bicyclic. It should be understood that, in the context of the invention, the expression “polycyclic aromatic radical” is understood to mean a radical having two or more aromatic rings that are fused (ortho-fused or ortho- and peri-fused) to one another, that is to say having, in pairs, at least two carbons in common.

By way of example of “aryl”, mention may be made of e.g. phenyl, xylyl and tolyl radicals.

Advantageously, the POS (I) has a viscosity at least equal to 200 mPa.s, preferably 1000 mPa.s and more preferably still between 5000 and 200 000 mPa.s.

In the present document, the viscosities indicated correspond to a value of dynamic viscosity measured at 25° C., using a Brookfield viscometer, according to the AFNOR NFT 76 106 standard of May 1982.

Of course, POS (I) may be a mixture of several oils corresponding to the same definition as POS (I).

POS (I) may be solely formed from units of formula (I.1) or may contain, in addition, units of formula (I.2).

POS (I) is advantageously a linear polymer, the diorganopolysiloxane chain of which is essentially composed of D or D^{Vi} siloxy units, and is blocked at each end by an M or M^{Vi} siloxy unit.

Preferably, at least 60% of the Z groups represent methyl radicals. The presence, along the diorganopolysiloxane chain, of small amounts of units other than Z₂SiO, for example units of formula ZSiO_{1.5} (T siloxy units) and/or SiO₂ (Q siloxy units) is not however ruled out in the proportion of at most 2% (these percentages expressing the number of T and/or Q units per 100 silicon atoms).

Examples of siloxy units of formula (I.1) are vinyldimethylsiloxy, vinylphenylmethylsiloxy, vinylmethylsiloxy and vinylsiloxy units.

Examples of siloxy units of formula (I.2) are the SiO_{4/2}, dimethylsiloxy, methylphenylsiloxy, diphenylsiloxy, methylsiloxy and phenylsiloxy units.

Examples of POS (I) are dimethylvinylsilyl-terminated dimethylpolysiloxanes, trimethylsilyl-terminated methylvinyldimethylpolysiloxane copolymers, dimethyl-vinylsilyl-terminated methylvinyldimethylpolysiloxane copolymers, and cyclic methylvinylpolysiloxanes.

These POS (I) are sold by silicone manufacturers or may be manufactured by carrying out techniques that are already known.

The polyorganosiloxane (II) is preferably of the type of those comprising the siloxy unit of formula:

H_{d}L_{c}SiO_{(4-(d-c))/2} (II.1)

in which:
L is a monovalent hydrocarbon-based group, free of any action unfavorable to the activity of the catalyst and chosen from alkyl groups having from 1 to 8 carbon atoms inclusive, optionally substituted by at least one halogen atom, and also from aryl groups;
d is 1 or 2, e is 0, 1 or 2 and d+e has a value between 1 and 3;
   and optionally other siloxy units of average formula:

L_{g}SiO_{(4-g)/2} (II.2)

in which L has the same meaning as above and g has a value between 0 and 3.

The dynamic viscosity of this polyorganosiloxane (II) is at least equal to 10 mPa.s and, preferably, it is between 20 and 1000 mPa.s.

The polyorganosiloxane (II) may be solely formed from units of formula (II.1) or may additionally comprise units of formula (II.2).

The polyorganosiloxane (II) may have a linear, branched, cyclic or network structure.

The group L has the same meaning as the group Z above.

Examples of siloxy units of formula (II.1) are:

H(CH₃)₂SiO_{1/2}, HCH₃SiO_{2/2}, H(C₆H₅)SiO_{2/2}.

Examples of siloxy units of formula (II.2) are the same as those indicated above for the examples of siloxy units of formula (I.2).

Examples of polyorganosiloxanes (II) are linear and cyclic compounds such as:
hydrogendimethylsilyl-terminated polydimethylsiloxanes;
copolymers containing trimethylsilyl-terminated poly(dimethyl)(hydrogenmethyl)siloxane units;
copolymers containing hydrogendimethylsilyl-terminated poly(dimethyl)(hydrogenmethyl)siloxane units;
trimethylsilyl-terminated polyhydrogenmethyl-siloxanes; and
cyclic polyhydrogenmethylsiloxanes.

The compound (II) may optionally be a mixture of a hydrogendimethylsilyl-terminated polydimethylsiloxane and a polyorganosiloxane bearing at least 3 SiH (hydrogensiloxy) functions.

Preferably, the proportions of the polyorganosiloxanes (I) and (II) are such that the molar ratio of the number of hydrogen atoms bonded to the silicon in the polyorganosiloxane (II) to the number of alkenyl radicals bonded to the silicon in the polyorganosiloxane (I) is between 0.4 and 10, preferably between 0.6 and 5.

The polyaddition reaction suitable for the crosslinking mechanism of the composition used in the invention is well known by a person skilled in the art. A catalyst (III) may furthermore be used in this reaction. This catalyst (III) may especially be chosen from platinum and rhodium compounds. It is possible, in particular, to use the complexes of platinum and of an organic product described in patents U.S. Pat. No. 3,159,601, U.S. Pat. No. 3,159,602, U.S. Pat. No. 3,220,972 and European patents EP-A-0 057 459, EP-A-0 188 978 and EP-A-0 190 530, the complexes of platinum and of vinyl organosiloxanes described in patents U.S. Pat. No. 3,419,593, U.S. Pat. No. 3,715,334, U.S. Pat. No. 3,377,432 and U.S. Pat. No. 3,814,730. The catalyst which is generally preferred is platinum. In this case, the amount by weight of catalyst (III), calculated by weight of platinum metal, is generally between 2 and 400 ppm, preferably between 5 and 100 ppm, based on the total weight of the POS (I) and (II).

Without this being limiting, it may be considered that the adhesion promoter (IV) exclusively comprises:
(IV.1) at least one alkoxylated organosilane containing, per molecule, at least one C₂-C₆ alkenyl group;
(IV.2) at least one organosilicon compound comprising at least one epoxy radical; and
(IV.3) at least one metal M chelate and/or a metal alkoxide of general formula: M(OJ)ₙ, with n=valency of M and J=linear or branched C₁-C₈ alkyl, M being chosen from the group formed by: Ti, Zr, Ge, Li, Mn, Fe, Al and Mg.

According to one preferred embodiment of the invention, the alkoxylated organosilane (IV.1) of the promoter (IV) is more particularly chosen from the products of the following general formula:

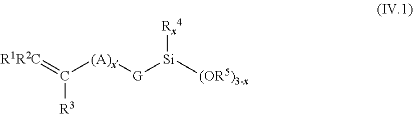

in which:
R¹, R² and R³ are hydrogen-based or hydrocarbon-based radicals, which are identical to or different from one another, and represent, preferably, hydrogen, a linear or branched C₁-C₄ alkyl or a phenyl optionally substituted with at least one C₁-C₃ alkyl;
A is a linear or branched C₁-C₄ alkylene;
G is a valency bond or oxygen;
R⁴ and R⁵ are identical or different radicals and represent a linear or branched C₁-C₄ alkyl;
x′=0 or 1; and
x=0 to 2.

Without this being limiting, it may be considered that vinyltrimethoxysilane is a particularly suitable compound (IV.1).

Regarding the organosilicon compound (IV.2), it is expected to be chosen:
either from the products (IV.2a) satisfying the following general formula:

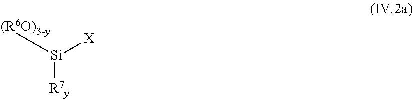

in which:
R⁶ is a linear or branched C₁-C₄ alkyl radical,
R⁷ is a linear or branched alkyl radical,
Y is equal to 0, 1, 2 or 3,

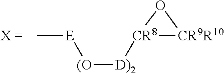

with
E and D, which are identical or different radicals, selected from linear or branched C₁-C₄ alkyls,
z, which is equal to 0 or 1,
R⁸, R⁹, R¹⁰, which are identical or different radicals, representing hydrogen or a linear or branched C₁-C₄ alkyl,
R⁸ and R⁹ or R¹⁰, which may alternately constitute together with the two carbons bearing the epoxy, a 5-membered to 7-membered alkyl ring,
or from the products (IV.2b) consisting of epoxy-functional polydiorganosiloxanes comprising at least one unit of formula:

XₚG_{q}SiO_{(4-(p+q))/2} (IV.2b₁)
in which:
X is the radical as defined above for the formula (IV.2a),
G is a monovalent hydrocarbon-based group, free of any action unfavorable to the activity of the catalyst and selected, preferably, from alkyl groups having from 1 to 8 carbon atoms inclusive, optionally substituted with at least one halogen atom, advantageously, from methyl, ethyl, propyl and 3,3,3-trifluoropropyl groups, and also from aryl groups,
p=1 or 2,
q=0, 1 or 2,
p+q=1, 2 or 3, and
optionally at least one unit of average formula:

GᵣSiO_{(4-r)/2} (IV.2 b₂)

in which G has the same meaning as above and r has a value of between 0 and 3, for example between 1 and 3.

With regard to the final compound (IV.3) of the adhesion promoter (IV), the preferred products are those in which the metal M of the chelate and/or of the alkoxide (IV.3) is selected from the following list: Ti, Zr, Ge, Li, Mn. It should be emphasized that titanium is more particularly preferred. It may be combined, for example, with an alkoxy radical of the butoxy type.

The adhesion promoter (IV) could be formed from:
(IV.1) alone
(IV.2) alone
(IV.1)+(IV.2),
according to two preferred conditions:
(IV.1)+(IV.3)
(IV.2)+(IV.3),
and finally according to the most preferred condition: (IV.1)+(IV.2)+(IV.3).

According to the invention, one advantageous combination for forming the adhesion promoter is the following:
vinyltrimethoxysilane (VTMO), 3-glycidoxy-propyltrimethoxysilane (GLYMO) and butyl titanate.

Quantitatively, it may be specified that the weight proportions between (IV.1), (IV.2) and (IV.3), expressed in percentages by weight with respect to the total of the three, are as follows:
(IV.1) 10%, preferably between 15 and 70% and more preferably still between 25 and 65%,
(IV.2) 90%, preferably between 70 and 15% and more preferably still between 65 and 25%,
(IV.3) 1%, preferably between 5 and 25% and more preferably still between 8 and 18%,

it being understood that the sum of these proportions of (IV.1), (IV.2) and (IV.3) is equal to 100%.

For better adhesion properties, the weight ratio (IV.2):(IV.1). Thus, this ratio is preferably between 2:1 and 0.5:1, the ratio 2:1 being more particularly preferred.

Advantageously, the adhesion promoter is present in an amount of from 0.1 to 10%, preferably 0.5 to 5% and more preferably still 1 to 3% by weight with respect to all of the constituents of the composition (A).

The mineral filler (V) may or may not be a reinforcing filler. It preferably comprises silicas, such as colloidal silicas, silicas prepared via a pyrogenic route (silicas known as pyrogenic or fumed silicas), or via wet processes (precipitated silicas) or mixtures of these silicas, calcium carbonates, quartz, silicones, aluminates and other oxides, kaolins, titanium dioxide or microspheres, for example glass microspheres. Fillers of all morphologies can be used, essentially spherical, acicular, foliated, lamellar and fibrillar fillers. Preferably, the filler has a hydrophobic surface, which may be obtained by treating the filler, for example with suitable silanes, short-chain siloxanes or fatty acids. These fillers and their treatment processes are known to a person skilled in the art and do not require additional description.

From a weight point of view, it is preferred to use an amount of filler (V) between 10 and 50%, preferably between 15 and 40%, and more preferably still between and 30% by weight relative to all of the constituents of the composition.

The crosslinking inhibitors (VI) are also well known. They are conventionally chosen from the following compounds:
polyorganosiloxanes, advantageously that are cyclic and substituted by at least one alkenyl, tetramethylvinyltetrasiloxane being particularly preferred;
pyridine;
phosphines and organic phosphites;
unsaturated amides;
alkyl maleates; and
acetylene alcohols.

These acetylene alcohols (cf. FR-B-1 528 464 and FR-A-2 372 874), which are among the preferred thermal hydrosilylation-reaction blockers, have the formula:

R—(R′)C(OH)—C≡CH

in which formula:
R is a linear or branched alkyl radical, or a phenyl radical;
R′ is H or a linear or branched alkyl radical, or a phenyl radical;
it being possible for the R, R′ radicals and the carbon atom located in the a position with respect to the triple bond to optionally form a ring; and
the total number of carbon atoms contained in R and R′ being at least 5, preferably from 9 to 20.

Said alcohols are, preferably, chosen from those having a boiling point above 250° C. Mention may be made, by way of examples, of:
1-ethynyl-1-cyclohexanol;
3-methyl-1-dodecyn-3-ol;
3,7,11-trimethyl-1-dodecyn-3-ol;
1,1-diphenyl-2-propyn-1-ol;
3-ethyl-6-ethyl-1-nonyn-3-ol; and
3-methyl-1-pentadecyn-3-ol.

These α-acetylene alcohols are commercial products.

Such an inhibitor (VI) is present in an amount of at most 3000 ppm, preferably in an amount of 100 to 1000 ppm relative to the total weight of the organopolysiloxanes (I) and (II).

According to one variant, the silicone phase of the composition may comprise at least one polyorganosiloxane resin (VII), optionally composed of at least one alkenyl residue in its structure, and this resin has a weight content of alkenyl group(s) between 0.1 and 20% by weight and preferably between 0.2 and 10% by weight.

These resins are branched organopolysiloxane oligomers or polymers that are well known and that are commercially available. They are preferably in the form of siloxane solutions. They comprise, in their structure, at least two different units chosen from the M, D, T and Q units, at least one of these units being a T or Q unit.

Preferably, these resins are alkenyl (vinyl) resins. As examples of branched organopolysiloxane oligomers or polymers, mention may be made of MQ resins, MDQ resins, TD resins and MDT resins, the alkenyl functions possibly being borne by the M, D and/or T units. As examples of resins which are particularly suitable, mention may be made of vinyl MDQ or MQ resins having a weight content of vinyl groups between 0.2 and 10% by weight, these vinyl groups being borne by the M and/or D units.

This compound (VII) has the role of increasing the mechanical strength of the silicone elastomeric coating and also its adhesion, in the context of the coating of the faces of a synthetic fabric (for example made of polyamide), stitched to form airbags. This structured resin is advantageously present in a concentration between 10 and 70% by weight relative to all of the constituents of the composition, preferably between 30 and 60% by weight, and more preferably still between 40 and 60% by weight. Particularly preferably, the polyorganosiloxane resin (VII) will comprise at least 2% by weight of SiO₂ units (Q units), in particular from 4 to 14%, preferably from 5% to 12%.

As an additive (IX) for improving the fire resistance, mention may be made, for example, of compounds having a phenyl group substituted by an amino group (secondary or tertiary amino group). Examples of such additives are found in the reference U.S. Pat. No. 5,516,938. The useful amounts of such additives are generally between 0.01 and 1 part by weight relative to the total amount of the composition.

For storage reasons, the silicone composition (A) is advantageously provided in the form of an at least two-component system, the mixture of which is capable of rapidly crosslinking at high temperature via polyaddition. The ingredients are then distributed in the various parts according to the rules of the person skilled in the art; in particular, the catalyst is separated from the component that comprises the hydrogensiloxanes.

According to another variant of the invention, the silicone composition is a crosslinkable composition (B) comprising:
B.I—a system that generates a film-forming silicone network comprising at least one polyorganosiloxane (POS) resin having, per molecule, on the one hand at least two different siloxy units chosen from those of M, D, T, Q types, one of the units being a T unit or a Q unit and, on the other hand, at least three hydrolyzable/condensable groups of OH and/or OR² types where R² is a linear or branched C₁ to C₆ alkyl radical;
B.II—a system that promotes the anchoring of said network to the surface of the textile consisting of:
   either 1) at least one metal alkoxide of general formula:

M[(OCH₂CH₂)ₐOR³]ₙ (B.I)
in which:
M is a metal chosen from the group formed by: Ti, Zr, Ge, Si, Mn and Al;
n=valency of M;
the R³ substituents, which are identical or different, each represent a linear or branched C₁ to C₁₂ alkyl radical;
a represents zero, 1 or 2;
with the conditions according to which, when the symbol a represents zero, the R³ alkyl radical has 2 to 12 carbon atoms, and when the symbol a represents 1 or 2, the R³ alkyl radical has 1 to 4 carbon atoms; and
optionally, the metal M is connected to a ligand;
or 2) at least one metal polyalkoxide that ensues from the partial hydrolysis of the monomer alkoxides of formula (B.I) in which the symbol R³ has the aforementioned meaning with the symbol a representing zero;
or a combination of 1) and 2);
or 3) a combination of 1 and/or 2 with:
   at least one optionally alkoxylated organosilane containing, per molecule, at least one C₂-C₆ alkenyl group;
   and/or at least one organosilicon compound comprising at least one epoxy, amino, ureido, isocyanate and/or isocyanurate radical;
B.III—a functional additive consisting of:
   either 1) at least one silane and/or at least one essentially linear POS and/or at least one POS resin, each of these organosilicon compounds being equipped, per molecule, on the one hand with anchoring function(s) (AF(s)) capable of reacting with B.I and/or B.II or capable of generating in situ functions capable of reacting with B.I and/or B.II and, on the other hand, hydrophobicity function(s) (HF(s)), which may be identical to or different from the AF functions;
   or 2) at least one hydrocarbon-based compound comprising at least one linear or branched, saturated or unsaturated hydrocarbon-based group and optionally one or more heteroatom(s) other than Si and that is in the form of a monomer, oligomer or polymer structure, said hydrocarbon-based compound being equipped, per molecule, on the one hand with anchoring function(s) (AF(s)) capable of reacting with B.I and/or B.II or capable of generating in situ functions capable of reacting with B.I and/or B.II and, on the other hand, hydrophobicity function(s) (HF(s)), which may be identical to or different from the AF functions;
   or 3) a mixture of 1) and 2);
B.IV—optionally a non-reactive additive system consisting of: (i) at least one organic solvent and/or one non-reactive organosilicon compound; (2i) and/or water; on condition that use is made of the following (the parts are given by weight):
   per 100 parts of constituent B.I,
   from 0.5 to 200 parts of constituent B.II,
   from 1 to 1000 parts of constituent B.III, and
   from 0 to 10 000 parts of constituent B.IV.

Such a composition is described, for example, in French patent FR 2 865 223.

The viscosity of the silicone composition (A) or (B) may be adjusted by playing with the amounts of the constituents and by choosing polyorganosiloxanes of different viscosities. Preferably, the silicone composition used in the invention is solvent free. There will therefore be no solvent to remove or to recycle.

Whilst the transfer coating technique is generally associated in the paper field with fluid (dynamic viscosity between 1 and 1000 mPa.s) coating compositions, the process according to the invention makes it possible, against all expectations, to work at high dynamic viscosities, preferably which are greater than or equal to 3000 mPa.s, preferably greater than or equal to 5000 mPa.s, and more preferably still greater than or equal to 8000 mPa.s and even greater than or equal to 30 000 mPa.s, while still obtaining textile supports that comprise silicone coatings of low mass per unit area but that have excellent functional performances.

Depending on the field of application of the present invention, the silicone compositions may have a dynamic viscosity between, for example, 20 000 and 50 000 mPa.s, or between 100 000 and 300 000 mPa.s.

Once the silicone composition is ready to be used, it is applied to a textile support in accordance with the process according to the invention, that is to say by transfer coating using a coating machine comprising a coating head having at least three elements, that is to say a press roll, a coating roll and a metering roll, the optional other elements being metering elements, only the coating and press rolls being in contact with the textile support.

Particularly advantageously, the metering element has a globally circular cross section, that is to say it does not have a protuberance that forms a doctor blade.

Preferably, the metering element is a roll, referred to as a metering roll. However it is obvious that the metering element may be any appropriate metering means, namely a doctor blade, an extruder, a supply slot or nozzle, a curtain coating type system, or any other element that makes it possible to form a film of silicone on the coating roll.

Such a machine comprises, for example, a 5-roll coating head and a crosslinking oven. These coating machines are known in the field of paper coating. However paper is a flat support. This is why there was a bias according to which this type of machine was not suitable for a textile support, which is not flat. Similarly, for a person skilled in the art, this technology is not suitable for compositions of high viscosity.

Such a machine comprises an unwinder from which the textile support is unwound, a coating head, and means for conveying the textile support, at least one oven, and a winder, so that once coated, said support passes through one or more tunnel ovens in order to crosslink the coating, then is wound on the winder.

Even when the silicone composition used in the invention can crosslink or dry at room temperature, it is preferred to accelerate the crosslinking or the drying by thermal means and/or by electromagnetic radiation (UV or electron beam or infrared radiation), in accordance with step 3 of the process according to the invention. The temperature during the crosslinking or drying step is preferably below 210° C., and more preferably still between 90 and 190° C. The dwell time in the ovens is a function of the temperature; it is generally around 10 to 60 seconds at a temperature of around 160 to 180° C.

Particularly advantageously, the coating machine used in the process according to the invention does not comprise a doctor blade in contact with the textile support. Thus, the textile support is not damaged when it passes through the coating machine.

Preferably, the coating and press rolls corotate in the same direction of movement as the textile support. However, it is obvious that these rolls may also counter-rotate.

Preferably, the coating and metering rolls corotate. However, it is obvious that these rolls may also counter-rotate.

Particularly advantageously, the speed ratio of the coating roll to the metering roll is greater than or equal to 1.2, preferably greater than or equal to 2, and more preferably still greater than or equal to 3.

Advantageously, the coating head comprises 5 rolls, that is to say a press roll, a coating roll, and three metering rolls, the optional other rolls being metering rolls, preferably all co-rotating in the direction of movement of the textile support. The metering rolls make it possible to first significantly shear the silicone composition between said metering rolls and the coating roll. This makes it possible to control the thickness of the silicone film formed on the rolls.

The rolls may be made of metal or covered with rubber, or made of any other material including ceramics.

Particularly advantageously, the distance between the metering roll and the coating roll is less than or equal to 50 μm, preferably less than or equal to 20 μm. Intimate contact between these two rolls makes it possible to better shear the silicone.

In order to promote this intimate contact, the metering roll and the coating roll may be made from different materials, for example one made of metal and the other covered with rubber.

The coating machine may comprise two coating heads arranged in order to coat the two faces of the textile support in a single pass. In this case, the roll which is the press roll for the coating on the lower face of the fabric is also the coating roll for the coating on the upper face of the fabric. The supply of silicone is then double.

As there is no doctor blade in contact with the textile support, the process according to the invention makes it possible to have a rate of travel of the textile support between 10 m/min and 500 m/min, and preferably between 20 m/min and 100 m/min.

According to one particularly advantageous feature of the process of the invention, the amount of silicone composition applied to the textile support is less than or equal to 30 g/m², preferably less than or equal to 20 g/m², and more preferably still less than or equal to 15 g/m².

The process according to the invention may be used for coating textile supports, namely woven, plaited, knitted or non-woven fiber supports and, preferably, woven, knitted or non-woven supports made of natural fibers, synthetic fibers (advantageously made of polyester or of polyamide) or mixed fibers. The process according to the invention is particularly suitable for delicate fabrics, such as glass cloth or carbon cloth.

The invention also targets a support made from a woven, knitted or non-woven textile material, coated on one or two faces with a silicone coating, capable of being obtained by the process as described above.

Such a textile support as defined above, coated on one or two faces with a silicone coating, is characterized in that the silicone coating continuously follows the outer surface of the filaments of the textile.

Preferably, it has, at any point, a thickness E such that the thickness index I, defined by

$$I = \frac{E ( μ )}{G ( g \text{/} {m}^{2} )} ,$$

is less than or equal to 3, preferably less than or equal to 2, and more preferably still less than or equal to 1.5, G being the average mass per unit area of the silicone coating.

The average mass per unit area G is obtained by dividing the amount of silicone composition (in g) used for the coating by the surface area of the support to be covered (in m²).

The coating obtained is in the form of a thin layer of homogeneous thickness, so that the amount of silicone composition necessary to cover the support is less than that necessary to cover the same support when using a doctor blade coating machine, without impairing its functional performances.

According to one very advantageous feature of the invention, the support has an average mass per unit area of the silicone coating of less than or equal to 30 g/m², preferably less than or equal to 20 g/m², and more preferably still less than or equal to 15 g/m².

Preferably, the silicone coating is obtained from a crosslinkable silicone composition (A) or (B) as described above.

The support according to the invention is preferably an open-weave fabric having a porosity greater than 10 l/dm²/min according to the ISO 9237 standard. The expression “open-weave support” is understood to mean supports having a porosity of greater than 10 l/dm²/min according to the ISO 9237 standard. In the case of a woven fabric, it is especially possible to define the open weave as corresponding to a number of warp and weft yarns per centimeter, the sum of which is less than or equal to 36. As woven fabrics particularly recommended in the context of the present invention, mention will generally be made of the woven fabrics whose weight in the non-coated state is less than 200 g/m² and especially less than or equal to 160 g/m². Mention may thus be made of such woven fabrics, in particular made of polyamide or polyester, having from 10×10 to 18×18 yarns/cm, for example woven fabrics of 470 dtex (decitex) having these characteristics. It will be noted that use could also be made of substrates formed from technical textile fibers, that is to say textile fibers having improved properties relative to conventional fibers, for example increased tenacity, in order to confer particular or strengthened properties as a function of the applications of the coated fabric or support.

The support according to the invention may be, for example, flat fabric composed of a single element or the textile may be composed of at least two elements woven in a single step to form a single seamless part.

Another aspect of the invention relates to an airbag for protecting of a vehicle occupant, formed from a coated support as described above, or prepared according to the process of the invention described above.

Particularly advantageously, the airbag for the protection of a vehicle occupant according to the invention is a single seamless part composed of two elements woven in a single step, referred to as an OPW (one piece woven) airbag. The support is then preferably a polyamide fabric.

The textile support according to the invention may also be used for manufacturing technical fabrics such as, in particular, tent canvasses, parachute cloths and the like.

It may also be incorporated in the manufacture of articles of clothing such as sports clothes or clothes suitable for taking part in outdoor activities.

Surprisingly, the support obtained by the process according to the invention, comprising for example a silicone coating of average mass per unit area equal to 20 g/m², has better functional and pressure resistance performances than a support comprising a silicone coating of the same average mass per unit area but coated using a doctor blade.

By virtue of the properties and features indicated above, airbags for the individual protection of the occupants of a vehicle can be produced from open-weave fabrics as described above, in particular made of polyamide or polyester fabric, which once coated, have a good resistance to edgecombing and to tearing, a weight of less than or equal to 200 g/m², and that have, furthermore, optimal properties in particular of impermeability, of heat protection, of porosity and of flexibility. This makes it possible to produce airbags that are lighter, have higher performance and are less expensive than the airbags produced from fabrics coated according to the processes of the prior art.

Generally, the coating in question here may correspond to the deposition of a single layer on at least one of the faces of the flexible support material (primary coat). But it may also be the deposition of a second layer or optionally of a third layer on at least one of the faces of the already coated support material (secondary coats) in order to have in total the desired thickness that guarantees the best possible performances in terms of impermeability and favorable feel characteristics.

The examples which follow, of preparation of compositions and of their application as a coating for a polyamide fabric according to the process of the invention will make it possible to better understand the invention and to highlight its advantages and its embodiment variants. The performances of the products resulting from the process according to the invention will be demonstrated by comparative tests.

### DESCRIPTION OF THE FIGURES

FIGS. 1 to 4 are various schematic representations of the coating head of the machine which may be used in the various examples according to the invention.

FIG. 5 is a photograph of observation of a surface view using a scanning electron microscope (×50 enlargement) of a woven fabric obtained according to example 2.

FIG. 6 is a photograph of observation of a cross-sectional view using a scanning electron microscope (×100 enlargement) of a woven fabric obtained according to example 3.

FIG. 7 is a photograph of observation of a cross-sectional view using a scanning electron microscope (×100 enlargement) of a woven fabric obtained according to example 4.

FIG. 8 is an enlarged view of FIG. 7 (×200 enlargement) of a woven fabric obtained according to example 4.

FIGS. 9 and 10 are photographs of observation of a cross-sectional view using a scanning electron microscope (×100 and ×200 enlargement) of a woven fabric obtained according to example 5.

### DESCRIPTION OF THE TESTS

The coated weight is measured by differential weighing between a coated sample and an uncoated sample, preferably a precursor of the fabric before the coated zone.
Tear measurement: the measurements of tear resistance are carried out according to the protocol following the ISO 13937-2 standard.
Measurement of the edgecomb resistance: the measurements of edgecomb resistance are carried out according to the indications of the ASTM D 6479 standard.
Test of resistance to rubbing and to abrasion (“scrub” test) (ISO 5981 A standard). This test reflects the adhesion and the resistance to aging of the composition. This test consists in subjecting the fabric, on the one hand, to a shear movement using two jaws that pinch the two opposite edges of a test specimen and that are driven by an alternating movement of one relative to the other and, on the other hand, to an abrasion by contact with a moving support.
Dynamic permeability test.

The apparatus consists of two chambers of known volume. Firstly, the test consists in filling the first chamber with a pressurized gas, in this case air, and in making it leaktight by sealing the inlet valve. A sample of coated fabric is mounted on a hollow plate, the coated face being pointed towards the second chamber, which is itself filled with ambient air.

At time t=0, a solenoid valve is released in order to bring the first chamber into communication with the second chamber, so as to abruptly apply an overpressure to the coated support. This pressure is 100 kPa. As the system is leaktight, the pressure is now homogeneous in the two chambers and the losses only occur through the coated fabric. The reduction of the pressure in the chamber is then measured as a function of time. In general, the time needed for the pressure to fall to 50 kPa (loss of 50%) is monitored: the longer this time is, the better the pressure is maintained and the more leaktight the sample is. A fabric is considered to be leaktight when the pressure drops by 50% in more than 3 seconds.

### Examples

### Examples of Coating Heads

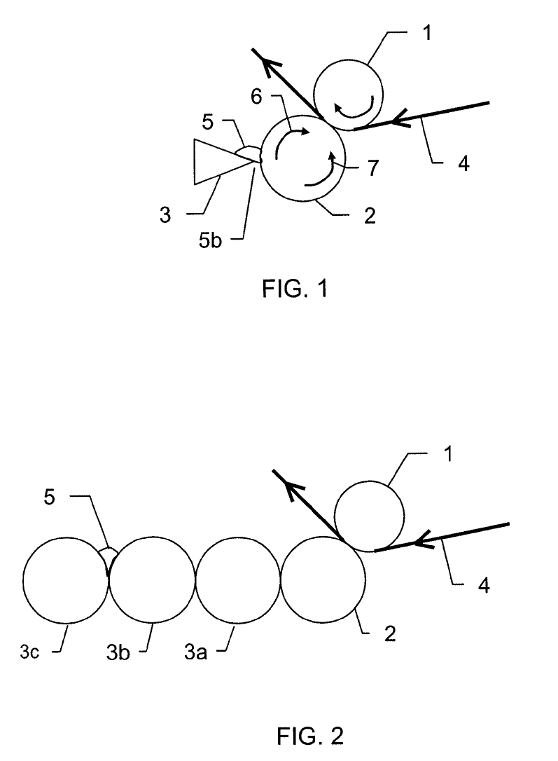

Various configurations of coating heads may be used in the process according to the invention. Such configurations are represented by FIGS. 1 to 4.

FIG. 1 is a schematic representation of a transfer coating head with a press roll 1 conveying the fabric 4, a coating roll 2 and a metering element 3. Only the coating roll 2 and the press roll 1 are in contact with the fabric 4. The feeding of the silicone 5 takes place via the metering element 3. This metering element 3 may be a doctor blade, an extruder, a nozzle, a slot, another roll, or any other element that makes it possible to form a film of silicone on the coating roll 2. The coating roll 2 may co-rotate relative to the press roll 1 and to the fabric 4 (direction 7).

The coating roll 2 may also counter-rotate relative to the press roll 1 and to the fabric 4 (direction 6). In this case, the feeding of the silicon will take place on the side 5b.

The machine does not comprise any doctor blade in contact with the fabric 4.

FIG. 2 is a schematic representation of a 5-roll transfer coating head where the metering element is composed of 3 metering rolls 3a, 3b and 3c. The feeding of the silicone 5 takes place, for example, between the first two metering rolls 3c and 3b. The silicone film thus formed is then transferred to the roll 3a then to the coater 2 and thus to the fabric 4.

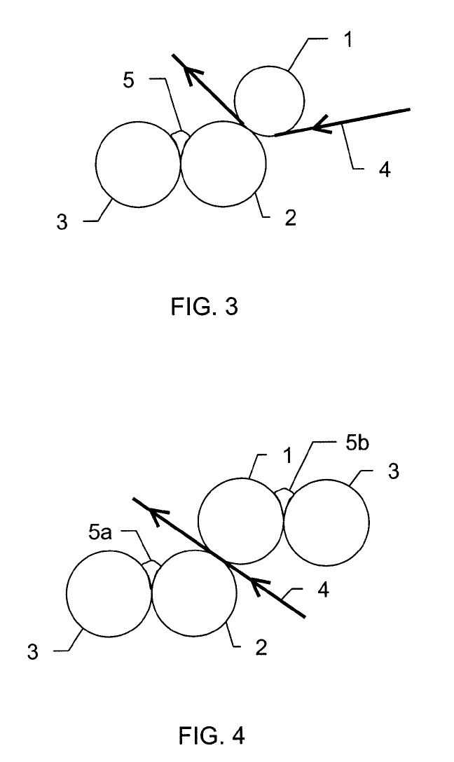

FIG. 3 is a schematic representation of a 3-roll transfer coating head, which is a preferred embodiment of the invention. The metering element is the roll 3. During use of the coating roll 2 co-rotating with the direction of movement of the fabric 4, the feeding of the silicone may take place at position 5.

FIG. 4 represents an assembly of two 3-roll transfer coating heads for coating the two faces of the fabric in a single pass. In this case, the roll 1, which is the presser for coating on the lower face of the fabric 4, is also the coater for coating on the upper face of the fabric 4. The feeding of the silicone is then double and may for example take place at positions 5a and 5b.

### Example 1

### Invention

1) Use is made of a liquid silicone elastomer based on a 100/10 mixture by weight of TCS 7534A and TCS 7534B red sold by Bluestar Silicones. This is an elastomer that can be vulcanized by polyaddition.
A composition having a dynamic viscosity of 48 000 mPa.s is obtained.
2) The composition obtained is then applied to a woven fabric of continuous synthetic yarns made of polyamide PA-6,6 having a linear density of 470 decitex (dtex) and having a thread count of 18×18 yarns/cm. This application is carried out by transfer coating using a pilot coating machine, the coating head of which corresponds to the scheme from FIG. 3.

The metering roll 3 is metallic and fixed, the coating roll 2 is made of rubber having a Shore A hardness of 80, rotating at 100% of the speed of the fabric, and pushed against the metering roll by a pressure of 15 bar, and the press roll 1 is metallic and conveys the fabric at 40 m/min. The contact of the press roll on the coating roll leaves a 9 mm imprint on the fabric.

The amount of silicone composition deposited is 18 g/m².

3) The fabric, once coated, passes into 3 successive ovens each 2 m long. The maximum temperature of the ovens is 220° C., which corresponds to 180° C. on the surface of the fabric. The silicone elastomer is crosslinked in these ovens and the fabric, once it has passed through two water-cooled rolls, has a dry and non-tacky feel.

A support of homogeneous appearance, without defects or visible asperities, is obtained. The covering of the fabric revealed by the red coloring of the coating appears continuous.

The scrub adhesion after a post-cure of 30 s at 180° C. is greater than 600 rubbings.

The tear strength is 287±5 N (217±6 N for the fabric alone) and the edgecomb resistance is 371±18 N (312±28 N for the fabric alone), i.e. a gain of 30% in the tear strength and of 20% in the edgecomb resistance.

The result of the dynamic permeability test is 10 s.

### Example 2

### Invention

1) Use is made of a liquid silicone elastomer based on a 99.3%/0.7% mixture by weight of TCS 7511A and TCS 7511D sold by Bluestar Silicones. This is an elastomer that can be vulcanized by polyaddition.

A composition having a dynamic viscosity of 2 500 mPa.s is obtained.

2) The composition obtained is then applied to a woven fabric of continuous synthetic yarns made of polyamide PA-6,6 having a linear density of 470 decitex (dtex) and having a thread count of 18×18 yarns/cm. This application is carried out by transfer coating using a pilot coating machine, the coating head of which comprises 3 rolls in accordance with FIG. 3: a metallic metering roll rotating at 60% of the speed of the fabric, a metallic coating roll rotating at 105% of the speed of the fabric, and pushed against the metering roll by a pressure of 15 bar via a spacer of 100 microns, and a rubber press roll conveying the fabric at 20 m/min. The contact of the press roll on the coating roll leaves a 9 mm imprint on the fabric.

The weight deposited is 15 g/m².

3) Step 3 is similar to that from example 1.

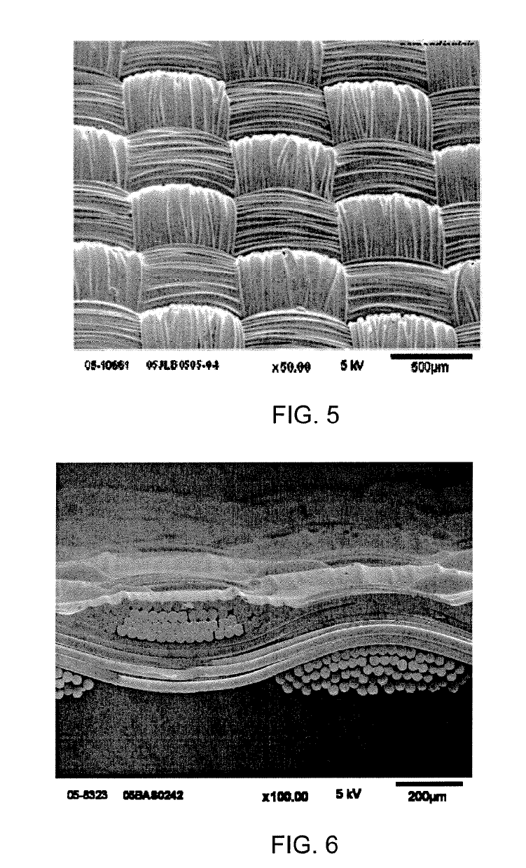

A support of homogeneous appearance, without visible asperities or defects, is obtained, the covering of the fabric by the coating appearing continuous. FIG. 5 shows that the coating is uniformly distributed, of constant thickness and follows the non-planar shape of the fabric. The coating follows the relief of the filaments and forms a continuous layer of silicone. The surface appearance is smooth. There are no damaged yarns. The process according to the invention makes it possible to coat the entire fabric with the same efficiency, using just the necessary amount of silicone to cover the surface of the fabric. The tops of the yarns are effectively protected and there is no accumulation of silicone between the yarns.

The scrub adhesion after a post-cure of 30 s at 180° C. is greater than 600 rubbings.

The tear strength is 350±22 N (217±6 N for the fabric alone) and the edgecomb resistance is 330±20 N (312±28 N for the fabric alone), i.e. a gain of 60% in the tear strength.

### Example 3

### Invention

1) Use is made of a liquid silicone elastomer based on a 100%/10% mixture by weight of TCS 7534A and TCS 7534B sold by Bluestar Silicones. This is an elastomer that can be vulcanized by polyaddition.

A composition having a dynamic viscosity of 44 000 mPa.s is obtained.

2) The composition obtained is then applied to a woven fabric of continuous synthetic yarns made of polyamide PA-6,6 having a linear density of 470 decitex (dtex) and having a thread count of 18×18 yarns/cm. This application is carried out by transfer coating using a pilot coating machine, the coating head of which comprises 5 rolls in accordance with FIG. 2: a first metallic metering roll rotating at 10% of the speed of the fabric, a second rubber metering roll rotating at 16% of the speed of the fabric, a third metallic metering roll rotating at 50% of the speed of the fabric, a rubber coating roll rotating at 110% of the speed of the fabric, and pushed against the metering roll by a pressure of 15 bar, and a metallic press roll conveying the fabric at 50 m/min. The contact of the press roll on the coating roll leaves a 16 mm imprint on the fabric.

The weight deposited is 22 g/m².

3) Step 3 is similar to that from example 1.

A support of homogeneous appearance, without visible asperities or defects, is obtained, the covering of the fabric by the coating appearing continuous. FIG. 6 shows that the coating is uniformly distributed, of constant thickness and follows the non-planar shape of the fabric. The coating follows the relief of the filaments and forms a continuous layer of silicone. The surface appearance is smooth. There are no damaged yarns. The tops of the yarns are effectively protected and there is no accumulation of silicone between the yarns.

The scrub adhesion after a post-cure of 30 s at 180° C. is greater than 600 rubbings.

### Example 4

### Invention

1) Use is made of a liquid silicone elastomer based on a 100%/10% mixture by weight of TCS 7534A and TCS 7534B sold by Bluestar Silicones. This is an elastomer that can be vulcanized by polyaddition.

A composition having a dynamic viscosity of 44 000 mPa.s is obtained.

2) The composition obtained is then applied to a woven fabric of continuous synthetic yarns made of polyamide PA-6,6 having a linear density of 470 decitex (dtex) and having a thread count of 18×18 yarns/cm. This application is carried out by transfer coating using a pilot coating machine, the coating head of which comprises 5 rolls in accordance with FIG. 2: a first metallic metering roll rotating at 10% of the speed of the fabric, a second rubber metering roll rotating at 15% of the speed of the fabric, a third metallic metering roll rotating at 60% of the speed of the fabric, a rubber coating roll rotating at 110% of the speed of the fabric, and pushed against the metering roll by a pressure of 15 bar, and a rubber press roll conveying the fabric at 50 m/min. The contact of the press roll on the coating roll leaves a 16 mm imprint on the fabric.

The weight deposited is 20 g/m².

3) Step 3 is similar to that from example 1.

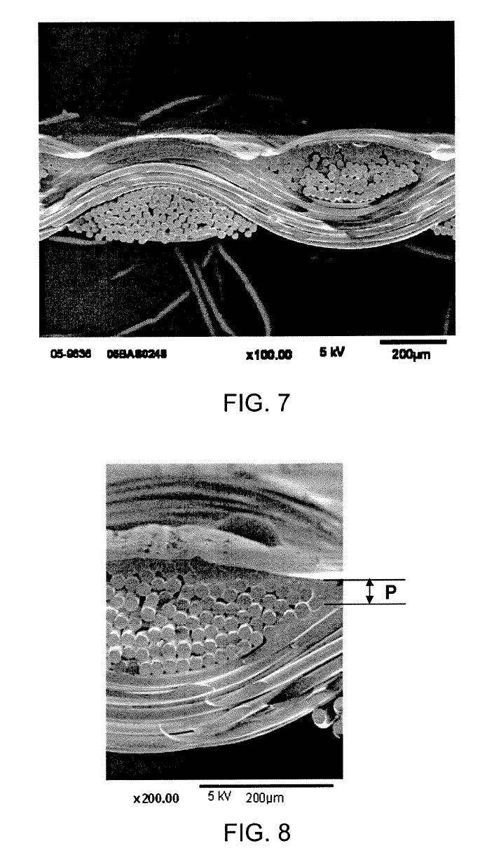

A support of homogeneous appearance, without visible asperities or defects, is obtained, the covering of the fabric by the coating appearing continuous. FIGS. 7 and 8 show that the coating is uniformly distributed, of constant thickness and follows the non-planar shape of the fabric. The coating follows the relief of the filaments and forms a continuous layer of silicone. The surface appearance is smooth. There are no damaged yarns. In particular, the thickness index I, corresponding to the thickness of the silicone film expressed in microns, measured for example at the location P on FIG. 8, relative to the coated weight of 20 g/m², always appears less than 2.

The scrub adhesion after a post-cure of 20 s at 180° C. is greater than 1200 rubbings.

The result of the dynamic permeability test is 15 s.

### Example 5

### Comparative

By way of comparison, the same silicone composition as in example 4 is used.

The same PA-6,6 polyamide fabric of 470 dtex comprising 18×18 yarns/cm is also used.

This composition is applied to this fabric by coating using a doctor blade. The crosslinking temperature is 180° C. for a dwell time in the oven of 50 in order to obtain an elastomer.

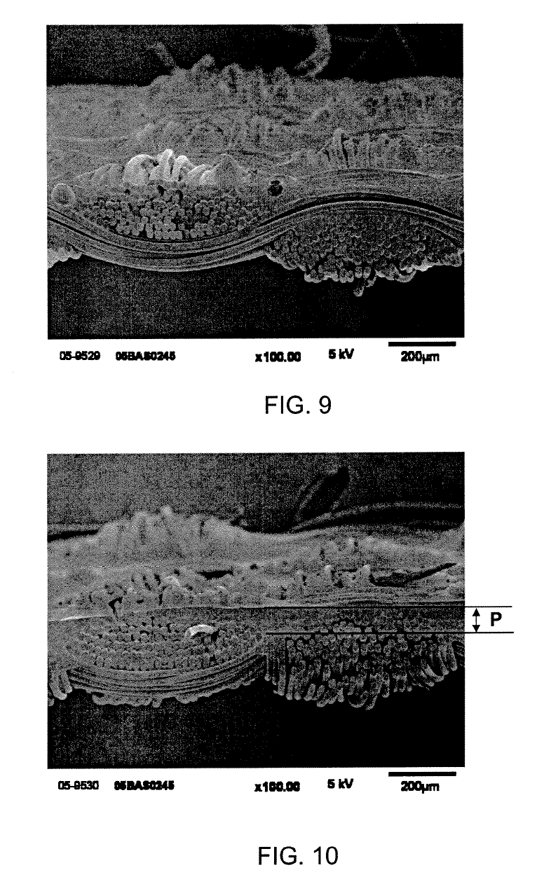

The weight deposited is also 20 g/m². The visual appearance of the coating is not homogeneous and the coating does not appear continuous. FIGS. 9 and 10 show that certain yarns are damaged by the doctor blade, certain filaments even emerging from the coating. In particular, the coating does not make it possible to place a continuous film on the surface of the fabric. The tops of the yarns appear exposed, whilst the blade has filled the spaces between the yarns with silicone. In particular, the thickness index I, corresponding to the thickness of the silicone film expressed in microns, measured for example at the location P on FIG. 10, relative to the coated weight of 20 g/m², appears equal to 77 microns/20 g/m²=3.85. There is therefore locally a lot more silicone between the yarns than on the tops thereof.

The scrub adhesion is greater than 1200 rubbings. The result of the dynamic permeability test is 1.5 s.

### Example 6

### Invention

1) Use is made of a liquid silicone elastomer based on a 67.8%/31.8%/0.4% mixture by weight of TCS 7512A/TCS 7511C/TCS 7511D sold by Bluestar Silicones. This is an elastomer that can be vulcanized by polyaddition.

A composition having a dynamic viscosity of 16 000 mPa.s is obtained.

2) The composition obtained is then applied to a woven fabric of continuous synthetic yarns made of polyamide PA-6,6 having a linear density of 470 decitex (dtex) and having a thread count of 18×18 yarns/cm. This application is carried out by transfer coating using a pilot coating machine, the coating head of which comprises 3 rolls in accordance with FIG. 3: a metallic metering roll rotating at 60% of the speed of the fabric, a metallic coating roll rotating at 105% of the speed of the fabric, and pushed against the metering roll by a pressure of 15 bar via a spacer of 100 microns, and a rubber press roll conveying the fabric at 20 m/min. The contact of the press roll on the coating roll leaves a 16 mm imprint on the fabric.

The weight deposited is 21 g/m².

3) Step 3 is similar to that from example 1.

A support of homogeneous appearance, without visible asperities or defects, is obtained, the covering of the fabric by the coating appearing continuous.

The scrub adhesion after a post-cure of 30 s at 180° C. is greater than 1000 rubbings.

The tear strength is 340±13 N (217±6 N for the fabric alone) and the edgecomb resistance is 380±40 N (312±28 N for the fabric alone), i.e. a gain of 55% in the tear strength and of 20% in the edgecomb resistance.

### Example 7

### Invention

1) Use is made of a liquid silicone elastomer based on a 99.6%/0.4% mixture by weight of TCS 7512A/TCS 7511D sold by Bluestar Silicones. This is an elastomer that can be vulcanized by polyaddition.

A composition having a dynamic viscosity of 30 800 mPa.s is obtained.

2) The composition obtained is then applied to a woven fabric of continuous synthetic yarns made of polyamide PA-6,6 having a linear density of 470 decitex (dtex) and having a thread count of 16×16 yarns/cm. This application is carried out by transfer coating using a pilot coating machine, the coating head of which comprises 3 rolls in accordance with FIG. 3: a metallic metering roll rotating at 30% of the speed of the fabric, a metallic coating roll rotating at 105% of the speed of the fabric, and pushed against the metering roll by a pressure of 15 bar via a spacer of 100 microns, and a rubber press roll conveying the fabric at 50 m/min. The contact of the press roll on the coating roll leaves a 7 mm imprint on the fabric.

The weight deposited is 27 g/m².

3) Step 3 is similar to that from example 1.

A support of homogeneous appearance, without visible asperities or defects, is obtained, the covering of the fabric by the coating appearing continuous.

The scrub adhesion after a post-cure of 30 s at 180° C. is greater than 1000 rubbings.

The tear strength is 330±13 N (240±10 N for the fabric alone) and the edgecomb resistance is 353±11 N (58±10 N for the fabric alone), i.e. a gain of 35% in the tear strength and of 500% in the edgecomb resistance.

### Example 8

### Invention

1) Use is made of a liquid silicone elastomer based on a 99.3%/0.7% mixture by weight of TCS 7511A/TCS 7511D sold by Bluestar Silicones. This is an elastomer that can be vulcanized by polyaddition.

A composition having a dynamic viscosity of 2 500 mPa.s is obtained.

2) The composition obtained is then applied to a woven fabric of continuous synthetic yarns made of polyamide PA-6,6 having a linear density of 470 decitex (dtex) and having a thread count of 16×16 yarns/cm. This application is carried out by transfer coating using a pilot coating machine, the coating head of which comprises 3 rolls in accordance with FIG. 3: a metallic metering roll rotating at 60% of the speed of the fabric, a metallic coating roll rotating at 105% of the speed of the fabric, and pushed against the metering roll by a pressure of 15 bar via a spacer of 100 microns, and a rubber press roll conveying the fabric at 20 m/min. The contact of the press roll on the coating roll leaves a 14 mm imprint on the fabric. The weight deposited is 27 g/m².

3) Step 3 is similar to that from example 1.

A support of homogeneous appearance, without visible asperities or defects, is obtained, the covering of the fabric by the coating appearing continuous.

The scrub adhesion after a post-cure of 30 s at 180° C. is greater than 1000 rubbings.

The tear strength is 349±5 N (240±10 N for the fabric alone) and the edgecomb resistance is 240±22 N (58±10 N for the fabric alone), i.e. a gain of 45% in the tear strength and of 300% in the edgecomb resistance.

### Example 9

### Invention

1) A polyaddition silicone elastomer having a viscosity of 150 000 mPa.s, and tinted blue, is used. This is a formulated two-component system based on vinyl-terminated polyorganosiloxanes having viscosities of 3500 to 100 000 mPa.s, on vinyl resins, on surface-hydrophobicized pyrogenic silica, on polyorganohydrogensiloxane crosslinkers comprising hydrogensiloxane functionalities in the middle and/or at the chain ends, having a viscosity of 5 to 400 mPa.s, on a catalyst which is a platinum complex, and on adhesion promoters comprising silanes that bear unsaturated double bonds and/or epoxy functionalities, and also an alkyl titanate.

2) The composition obtained is then applied to a fabric of polyamide PA-6,6 yarns having a linear density of 470 dtex and a thread count of 18×18 yarns/cm. The crosslinkable elastomer is applied to a 3-roll head according to FIG. 3, with a fixed metallic metering roll, a coating roll made of rubber having a Shore A hardness of 80, pressed against the metering roll by a pressure of 15 bar, and rotating at 105% of the speed of the fabric, and a metal press roll conveying the fabric at 20 m/min. The contact of the press roll on the coating roll leaves a 7 mm imprint on the fabric. The weight deposited is 16 g/m².

3) Step 3 is similar to that of example 1.

A support of homogeneous appearance without visible defects or asperities is obtained, the covering of the fabric revealed by the blue coloring of the coating appearing continuous.

The scrub adhesion is greater than 600 rubbings.

The tear strength is 378±14 N (217±6 N for the fabric alone) and the edgecomb resistance is 343±17 N (312±28 N for the fabric alone), i.e. a gain of 75% in the tear strength.

The result of the dynamic permeability test is 3 s.

### Example 10

### Invention

1) A polyaddition silicone elastomer obtained by mixing, by weight, 100/10 of TCS 7534A and TCS 7534B red, sold by Bluestar Silicones, is used. The viscosity of the system is 50 000 mPa.s.

2) The composition obtained is then applied to a “one piece woven” (OPW) fabric of polyamide PA-6,6 yarns having a linear density of 470 dtex and a thread count of 22×21 yarns/cm.

The crosslinkable elastomer is applied to a 3-roll head according to FIG. 3, with a metallic metering roll rotating at 80% of the speed of the fabric, a metallic coating roll rotating at 120% of the speed of the fabric, pushed against the metering roll by a pressure of 15 bar, and a metal press roll conveying the fabric at 20 m/min. The gap between the coating roll and the press roll corresponds to an imprint of 7 mm on a flat fabric as in example 7.

The weight deposited is 45 g/m² on the first and the second face.

3) Step 3 is similar to that from example 1.

A support of homogeneous appearance, without visible asperities or defects, in particular at the transition zones that appear covered, as revealed by the red coloring of the coating, is obtained.

The scrub adhesion is greater than 2000 rubbings. The tear strength is 345±15 N (210±10 N for the fabric alone) and the edgecomb resistance is 660±70 N (660±70 N for the fabric alone), i.e. an increase in the tear strength of 65%.

The above results show that the process according to the invention, regardless of the silicone composition and the type of fabric used, makes it possible to obtain supports that have very good functional and pressure resistance performances, despite low masses per unit area, and in particular masses per unit area of around 20 g/m².

The process according to the invention therefore makes it possible to reduce the amount of silicone used without compromising the functional performances or the leaktightness of the support. This process is therefore particularly profitable from an economic point of view. It also makes it possible to use less expensive supports, while nevertheless guaranteeing the desired functional properties. The process according to the invention also makes it possible to increase the leaktightness of the coated textile support while using a small amount of silicone.

1.-22. (canceled)

23. A process for producing a textile support having a silicone coating on one or two of the face surfaces thereof, comprising the following steps:
1) formulating a silicone composition;
2) applying the silicone composition prepared in step 1) onto one or two of the face surfaces of a textile support; and
3) drying and/or the crosslinking of the coating(s) deposited in step 2), optionally by heating at a temperature of up to 210° C.; and wherein the application in step 2) of the silicone composition onto the textile support is carried out by transfer coating employing a coating machine which comprises a coating head having at least three elements, including a press roll, a coating roll and a metering roll, and optionally other metering elements, only the coating and press rolls being in contact with the textile support and further wherein the speed ratio of the coating roll to the metering roll is greater than or equal to 1.2.

24. The process as defined by claim 23, wherein the coating machine is devoid of any doctor blade in contact with the textile support.

25. The process as defined by claim 23, wherein the distance from the metering roll and the coating roll is less than or equal to 50 μm.

26. The process as defined by claim 23, wherein the metering roll and the coating roll are manufactured from different materials.

27. The process as defined by claim 23, wherein the coating and press rolls corotate in the same direction of travel as the textile support.

28. The process as defined by claim 23, wherein the coating and metering rolls corotate.

29. The process as defined by claim 23, wherein the amount of silicone composition applied in step 2) is less than or equal to 30 g/m².

30. The process as defined by claim 23, wherein the silicone composition comprises a crosslinkable composition (A) including:
the components (a-1) or (a-2):
(a-1) comprises at least one polyorganosiloxane crosslinkable via the action of a catalyst based on at least one organic peroxide; and
(a-2) comprises a mixture of polyorganosiloxanes crosslinkable via polyaddition reactions including:
at least one polyorganosiloxane (I) having, per molecule, at least two C₂-C₆ alkenyl groups bonded to the silicon; and
at least one polyorganosiloxane (II) having, per molecule, at least two hydrogen atoms bonded to the silicon;
an effective amount of crosslinking catalyst comprising: when (a-1) is present, at least one organic peroxide and when (a-2) is present, at least one metal or metal compound from the platinum group (Ill);
optionally, at least one adhesion promoter (IV);
optionally, at least one mineral filler (V);
optionally, at least one crosslinking inhibitor (VI);
optionally, at least one polyorganosiloxane resin (VII); and
optionally, one or more functional additives for conferring specific properties.

31. The process as defined by claim 30, comprising an adhesion promoter (IV) of the crosslinkable silicone composition (A) which exclusively contains:
(IV.1) at least one alkoxylated organosilane containing, per molecule, at least one C₂-C₆ alkenyl group;
(IV.2) at least one organosilicon compound comprising at least one epoxy radical; and
(IV.3) at least one metal M chelate and/or a metal alkoxide of general formula: M(OJ)ₙ, with n=valency of M and J=linear or branched C₁-C₈ alkyl radical, with M being selected from the group consisting of Ti, Zr, Ge, Li, Mn, Fe, Al and Mg.

32. The process as defined by claim 30, wherein the polyorganosiloxane (I) comprises structural units of formula:
WₐZ_{b}SiO_{(4-(a+b))/2} (1.1)
in which:
W is an alkenyl radical;
Z is a monovalent hydrocarbon-based group, devoid of action adverse to the activity of the catalyst and selected from among alkyl radicals having from 1 to 8 carbon atoms, inclusive, optionally substituted by at least one halogen atom, and also from among aryl radicals;
a is 1 or 2, b is 0, 1 or 2 and a+b ranges from 1 to 3,
and optionally comprising structural units of average formula:
Z_{c}SiO_{(4-c)/2} (1.2)
in which Z is as defined above and c ranges from 0 to 3.

33. The process as defined by claim 30, wherein the polyorganosiloxane (II) comprises siloxy structural units of formula:
H_{d}LₑSiO_{(4-(d+e))/2} (11.1)
in which:
L is a monovalent hydrocarbon-based group, devoid of action adverse to the activity of the catalyst and selected from among alkyl radicals having from 1 to 8 carbon atoms, inclusive, optionally substituted by at least one halogen atom, and also from among aryl radicals;
d is 1 or 2, e is 0, 1 or 2 and d+e ranges from 1 to 3;
and optionally comprising siloxy structural units of average formula:
L_{g}SiO_{(4-g)/2} (11.2)
in which L is as defined above and g ranges from 0 to 3.

34. The process as defined by claim 30, wherein the proportions of the polyorganosiloxanes (I) and (II) are such that the molar ratio of the number of hydrogen atoms bonded to the silicon in the polyorganosiloxane (II) to the number of alkenyl radicals bonded to the silicon in the polyorganosiloxane (I) ranges from 0.4 to 10.

35. The process as defined by claim 23, wherein the silicone composition comprises a crosslinkable composition (B) including:
B.I—a system that generates a film-forming silicone network comprising at least one polyorganosiloxane (POS) resin having, per molecule, at least two different siloxy structural units selected from among those of M, D, T, Q types, one of the structural units being a T unit or a Q unit and at least three hydrolyzable/condensable groups of OH and/or OR² types wherein R² is a linear or branched C₁ to C₆ alkyl radical;
B.II—a system that promotes the anchoring of said network to the surface of the textile support which comprises:
either 1) at least one metal alkoxide of general formula:
M[(OCH₂CH₂)ₐOR³]ₙ (B.I)
in which:
M is a metal selected from the group consisting of Ti, Zr, Ge, Si, Mn and Al;
n=valency of M;
the R³ substituents, which may be identical or different, are each a linear or branched C₁ to C₁₂ alkyl radical;
a is zero, 1 or 2;
with the proviso that when the symbol a is zero, the R³ alkyl radical has 2 to 12 carbon atoms, and when the symbol a is 1 or 2, the R³ alkyl radical has 1 to 4 carbon atoms; and
optionally, the metal M is bonded to a ligand;
or 2) at least one metal polyalkoxide from the partial hydrolysis of the monomer alkoxides of formula (B.I) in which the symbol R³ is as defined above with the symbol a being zero;
or a combination of 1) and 2);
or 3) a combination of 1 and/or 2 with:
at least one optionally alkoxylated organosilane containing, per molecule, at least one C₂-C₆ alkenyl radical;
and/or at least one organosilicon compound comprising at least one epoxy, amino, ureido, isocyanate and/or isocyanurate radical;
B.III—a functional additive which comprises:
either 1) at least one silane and/or at least one essentially linear POS and/or at least one POS resin, each of these organosilicon compounds having, per molecule, anchoring function(s) (AF(s)) reactive with B.I and/or B.II or generating in situ functions reactive with B.I and/or B.II and hydrophobicity function(s) (HF(s)), which may be identical to or different from the AF functions;
or 2) at least one hydrocarbon-based compound comprising at least one linear or branched, saturated or unsaturated hydrocarbon-based group and optionally one or more heteroatom(s) other than Si and in the form of a monomer, oligomer or polymer structure, said hydrocarbon-based compound having, per molecule, anchoring function(s) (AF(s)) reactive with B.I and/or B.II or generating in situ functions reactive with B.I and/or B.II and hydrophobicity function(s) (HF(s)), which may be identical to or different from the AF functions;
or 3) a mixture of 1) and 2);
B.IV—optionally, a non-reactive additive system comprising: (i) at least one organic solvent and/or one non-reactive organosilicon compound; (2i) and/or water; with the proviso that same includes the following (the parts are given by weight):
per 100 parts of constituent B.I,
from 0.5 to 200 parts of constituent B.II,
from 1 to 1,000 parts of constituent B.III, and
from 0 to 10,000 parts of constituent B.IV.

36. The process as defined by claim 23, wherein the dynamic viscosity of the silicone composition is greater than or equal to 3,000 mPa.s.

37. The process as defined by claim 36, wherein the dynamic viscosity of the silicone composition is greater than or equal to 30,000 mPa.s.

38. A tear and edgecombing resistant textile support transfer coated on one or two of the face surfaces thereof with a thin, continuous, homogeneous and uniform silicone film coating having, at any point, a thickness E such that the thickness index I, defined by
$$I = \frac{E ( μ )}{G ( g \text{/} {m}^{2} )} ,$$
is less than or equal to 3, with G being the average mass per unit area of the silicone film coating.

39. The tear and edgecombing resistant textile support as defined by claim 38, coated on one or two of the face surfaces thereof with a silicone film coating, wherein the silicone film coating continuously follows the outer surface of the filaments of the textile.

40. The tear and edgecombing resistant support as defined by claim 38, wherein the average mass per unit area of the silicone film coating is less than or equal to 30 g/m².

41. The tear and edgecombing resistant support as defined by claim 38, wherein the textile support comprises an open-weave fabric having a porosity greater than 10 l/dm²/min according to the ISO 9237 standard.

42. The tear and edgecombing resistant support as defined by claim 38, wherein the textile support comprises at least two elements woven in a single step to form a single seamless structure.

43. An airbag for protecting a vehicle occupant comprising the tear and edgecombing resistant textile support as defined by claim 38.

44. A tear and edgecombing resistant textile support produced by the process as defined by claim 23.

45. A tear and edgecombing resistant textile support produced by the process as defined by claim 31.

46. A tear and edgecombing resistant textile support produced by the process as defined by claim 35.
